(19) United States
(12) Patent Application Publication
(10) Pub. No.: US 2013/0283158 A1
(43) Pub. Date: Oct. 24, 2013

(54) METHOD AND SYSTEM FOR DETERMINING A CONFIGURATION OF A DOCUMENT PRODUCTION ENVIRONMENT

(71) Applicants: Ray Uri Merriam, Rochester, NY (US); Derrick E. Shriver, Pittsford, NY (US); Eric Charles Carney, Henrietta, NY (US); Brian Donald Bacon, Macedon, NY (US); Nidhi Purohit, Rochester, NY (US); Andrew David Hinkhouse, Rochester, NY (US); John Arthur Wick, Mars, PA (US)

(72) Inventors: Ray Uri Merriam, Rochester, NY (US); Derrick E. Shriver, Pittsford, NY (US); Eric Charles Carney, Henrietta, NY (US); Brian Donald Bacon, Macedon, NY (US); Nidhi Purohit, Rochester, NY (US); Andrew David Hinkhouse, Rochester, NY (US); John Arthur Wick, Mars, PA (US)

(73) Assignee: XEROX CORPORATION, Norwalk, CT (US)

(21) Appl. No.: 13/452,190

(22) Filed: Apr. 20, 2012

(51) Int. Cl. G06F 17/00

(52) U.S. Cl. 715/273

(57) ABSTRACT

A system implements a method for approving and modifying a configuration of one or more print-related devices or other assets. The method displays a schematic of an environment and the assets in the environment, receives a user instruction to modify an asset; and determines a key metric for the asset. In response to the instruction, the system produces a modified schematic and presents it to one or more other users for approval. The system may selectively present portions of the schematic and/or the key metrics, depending on each user's authorization level.

### BACKGROUND

This application relates to a method and system for determining a configuration of an environment, and more particularly to a method and system for determining a configuration for equipment such as print-related devices and other assets in a document production environment.

It is often difficult to facilitate the configuration of assets in an environment. For example, when assets such as printers, copiers and other print-related devices are placed in an office or other document production environment, decisions about the number of assets and where they should be placed are often made on an ad hoc basis, without input from all people who may have useful input that could be considered in the decision. The logistics of displaying a configuration, modifying it, and getting approval from the appropriate users can be vary cumbersome. Many systems for performing this task would require long lead times before any final configuration could be approved. Users would not be able to easily modify a configuration and obtaining approval from the appropriate user would be time consuming.

This document describes methods and systems that address at least some of the problems described above, as well as other issues.

### SUMMARY

In an embodiment, a method is provided for approving and modifying a configuration of one or more assets. In some embodiments, the method comprises displaying, on an electronic display, a schematic of an environment depicting placement of one or more print-related devices or other assets in the environment; receiving, via a user interface, an instruction relating to at least one of the assets; determining a key metric for the identified asset or assets; in response to the instruction, modifying one or more characteristics of one or more of the assets in the schematic to produce a modified schematic; displaying the modified schematic on the display for approval; and receiving, via the user interface from a first user, an approval instruction; in response to the approval instruction, distributing the approved, modified schematic to a second user for additional approval; receiving, from the second user, an additional approval of the modified schematic. It is not necessary to print a physical copy of the configuration or schematic to obtain approval and/or modify the schematic. Accordingly, in some embodiments, the method is performed without printing a physical copy of the schematic until after the additional approval is received.

In some embodiments, the method also may include receiving, via the user interface from the first user, a modification instruction for the modified schematic; revising the modified schematic to produce a second modified schematic; displaying the second modified schematic on the display for approval; receiving, via the user interface, a second approval or a second modification instruction; and in response to the second approval, distributing the second modified schematic to a another user for additional approval or in response to the second modification instruction repeating the instructions until no additional modification instructions are received and the schematic is approved. The method also may include receiving a notification that the modified schematic has been approved.

In some embodiments, the method also may include determining whether the second user is authorized to access the key metric. If so, when distributing the modified schematic to the second user for approval, the system may include the key metric only if the second user is authorized to access the key metric.

In some embodiments, the instruction may include an instruction to add an additional print-related device, remove at least one of the print-related devices, change a location of at least one of the print-related devices, and/or modify a device configuration of at least one of the print-related devices. Thus, the modified characteristics may correspond to any of these instructions.

In some embodiments, the method may include determining whether the instruction is limited by one or more conditions, and only performing the modifying if the instruction satisfies the identified condition or conditions. The conditions may include, for example, a number of workers in the work area, a ratio of workers to print-related devices, a print-related device type, and a cost.

In some embodiments, the method also may include, in parallel with the distributing of the modified schematic to the second user: identifying a third user; creating a limited version of the modified schematic for review and approval by the third user; distributing the limited version of the modified schematic to the third user for approval; and making the modified version of the schematic available to all users of a workgroup only if approval is received from the third user. If at least one of the users has not approved the modified schematic; the method may include identifying the modified schematic as a conflict and resolving the conflict, such as by removing a change that resulted in the conflict.

Any or all of the steps described above may be implemented by a system that includes a computing device and a computer-readable storage medium that holds programming instructions for implementing the steps.

### BRIEF DESCRIPTION OF THE DRAWINGS

FIG. 1 illustrates an example of a networked system for determining a configuration of a document production environment.

FIG. 2 illustrates an example of a user interface for the system of FIG. 1.

FIG. 3 illustrates a method of determining a configuration for an environment according to an embodiment.

FIG. 4 illustrates a method of determining a configuration for an environment according to an embodiment.

FIG. 5 illustrates an example of a set of key metrics and access restrictions.

FIG. 6 illustrates internal hardware that may be used to contain or implement program instructions according to an embodiment.

### DETAILED DESCRIPTION

This invention is not limited to the particular systems, methodologies or protocols described, as these may vary. The terminology used herein is for the purpose of describing particular embodiments only, and is not intended to limit the scope of the present disclosure which will be limited only by the appended claims.

As used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

For purposes of the discussion below, an “asset” can be any object that is placed within an environment. For example, an asset can be, but is not limited to, an item of equipment in a production facility, such as a print-related device in a document production environment. A “print-related device” is a machine, device, document production device and/or the like used for document production. For example, a print-related device may be a printer, a scanner, a fax machine and/or the like.

An “environment” refers to an infrastructure having one or more assets. For example, an environment may be an office environment, a workshop environment, a print shop environment and/or the like. An environment may be a free-standing entity, or it may be part of a corporation or other entity. In an embodiment, an environment may include one or more facilities in one location or across multiple locations. An environment may be one or more floors of a building, a portion of a floor and/or the like. A document production environment is an environment in which documents are produced.

A “spatial entity” is the content of an area surrounding an asset. A spatial entity may include one or more users of the asset who are located within the area. For example, in an office environment, a spatial entity may encompass the users associated with one or more offices, desks, cubicles and/or the like located within the environment.

A “capability” is a function or operation that is performable by an asset, such as a print-related device. For example, capabilities of a print-related device may include fax, copy, scan, print, finishing operations and/or the like.

A “capability group” represents a group of users, print volume information associated with the users' output and any capabilities required by the users. In an embodiment, a capability group may include one or more spatial entities.

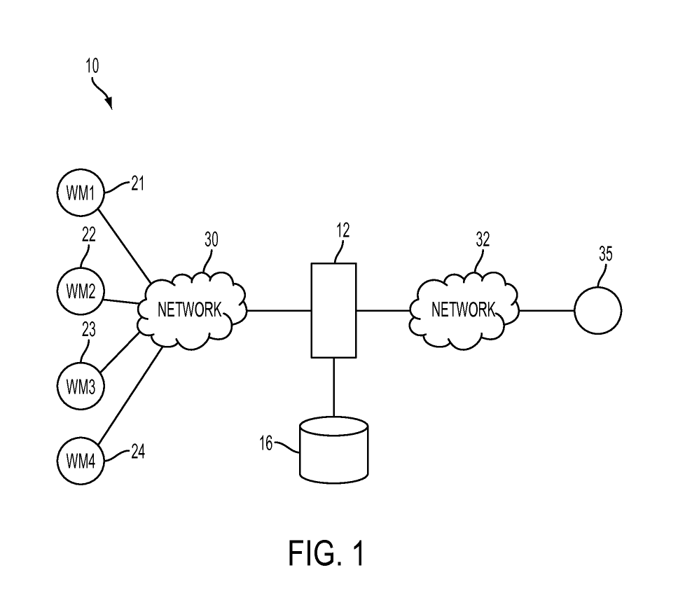

FIG. 1 illustrates an example of a collaborative environment transformation system 10, which includes a management server or servers 12 including a processor and computer-readable medium that holds one or more files that are used to prepare and display an environment and its assets. The server 12 may be in electronic communication with one or more data stores 16 that store information such as key metric data (described below), environment files, change requests, and the like. Any number of workgroup members 21, 22, 23, 24 may be in electronic communication with the management server 12 via a network 30. The workgroup members 21, 22, 23, 24 may include any number of workstations, such as computers, portable electronic devices, or other devices that may be operated by user who is authorized to access the files for the environment. The users of the workgroup may be individuals who share a common organizational structure, such as employees or contractors who are hired by, or members of, a single entity. Alternatively, the users may be part of separate entities, and the entities may share a contractual or collaborative relationship. The management server 12 also may share the environment data with an external user 35 via a network 32. The external user 35 may be an electronic device operated by a user who is not a member of the workgroup. For example, the workgroup may be made up of employees of an architectural firm, and the external user 35 may be a customer of that firm.

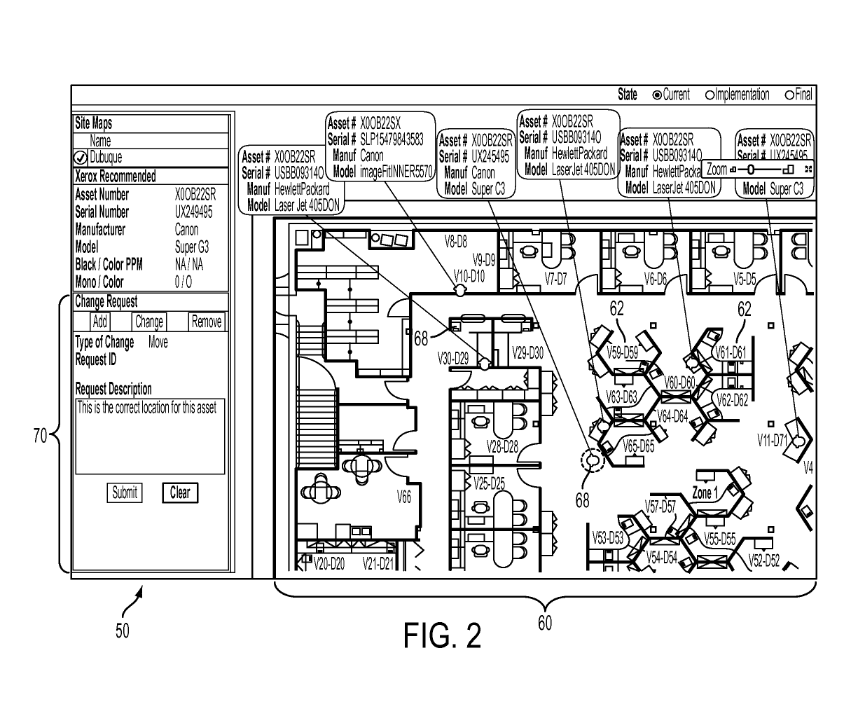

FIG. 2 illustrates a graphical user interface 50 that a workgroup member may use as part of a configuration system. The user interface 50, which may be displayed on an electronic display that is connected to a processor and computer-readable memory, may include an environment display field 60 depicting the placement of one or more assets in the environment. In the example of FIG. 1, the environment is an office that, among other things, produces documents. The environment includes, among other things, multiple user workstations 62 and multiple print-related resources 68.

The system also may include a user input interface. The user interface may be a separate item of hardware, such as a keyboard, touch pad and/or mouse. Optionally, the graphical user interface 50 itself may be at least a part of the user input interface. For example, the graphical user interface may be a touch-screen display that also provides user input capability. Other examples of the input interface may include, but are not limited to, a keyboard, a mouse, a joystick, a keypad, a touch screen, soft keys, and the like. The output portion of the user interface provides an audible, visual, mechanical or other output and/or feedback to the user. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface may include, among other devices or elements, any or all of a speaker, a display, a mouse, a keyboard, touch screen, or the like. The user interface can be used to control or modify the characteristics of one or of the assets depicted in the environment.

Information about the environment may be saved in a data file and stored in a memory that is accessible to multiple users in a networked system. Each environment may be associated with a workgroup, which is a set of known users. Each of the users in the workgroup may identify himself or herself to the system through an authentication token, such as a biometric identifier, or a username and password. Thus, all users of a workgroup can see the environment on their displays, and any or all users of the workgroup may be permitted to submit change requests.

The user can use the user interface to submit a request to modify the schematic of the environment. The instructions requested by the user can be to modify one or more characteristics of the one or more assets depicted in the schematic. These instructions can lead to the production of a modified schematic. The characteristics that can be modified include, but are not limited to, the location, number, size and configuration of any assets. For example, in the illustration of FIG. 2, the user may use the user interface to request that the system add, delete or move one or more of the workstations 62, as well as add, delete or move one or more of the print-related devices 68. Changes that a user requests may be saved to the system's memory, and optionally not immediately made on the displayed configuration of the environment 60. Instead, the change may be saved and displayed to the user and/or other users in a change request field 70. The change requests may be required to be approved before they are accepted and saved as a change.

In some embodiments, the environment configuration shown in FIG. 2 may be viewable by multiple users, using multiple display devices and user interfaces that are interconnected across a network. Change requests made at one user interface may be saved to a networked memory device and made available to other users to view at their displays. In some embodiments, users may present credentials to access the system, and only members whose credentials match those of one or more workgroup members may be permitted to access the environment data. In some embodiments, administrators who enter administrator credentials into their user interfaces may be the only users who are authorized to approve change requests. In other embodiments, all members of a workgroup, or a majority of members of a workgroup, or some other ratio or percentage of members of the workgroup, must approve a change request before it will be implemented in the graphic representation of the environment.

When a user submits a change request, the system may determine a set of key metrics for the request. Key metrics may include, for example, cost of the change, the number of environment users who are affected by the change, a cost per user for the change, a change in per-user or total equipment capacity that will result from the change, an internal target volume or other target measurement, and/or other metrics. For example, in an environment that includes a number of print-related devices, a key metric may be the number of workers per print-related device. When a user submits a change request, the user may enter one or more of the key metrics when entering the request (e.g., make/model of device), or the system may automatically determine one or more key metrics for the change (e.g., by updating the workers-per-device metric that will result after the change, or by determining a cost based on known cost information for the device make/model, or by determining an available printing capacity for the environment after the change by summing the pre-change capacity with a determined capacity of a device that the change will add).

Upon producing a modified schematic, the modified schematic can be displayed on the display. The display can be the same display that the user used to make the modifications or it may be another user's display. The modified schematic can be distributed to other users to obtain their approval. Alternatively, the modified schematic can be distributed electronically in a specific order to different users. For example, the modified schematic, optionally along with one or more key metrics, may be saved in a data file of any suitable format (such as Portable Document Format) and sent to another user for review

In some embodiments, a first user has to approve the modified schematic before a second user is given the opportunity to approve the modified schematic. If the first user fails to approve the modified schematic, the modified schematic is never displayed for the second user. Alternatively, in some embodiments, if a first user fails to review the modified schematic, the method can be manipulated such that the first user's approval is automated after a certain period of time. The approval can then allow another user to approve the modified schematic. This is just one example, variables can be set up that would allow the approval process to be moved along without getting an explicit approval instruction. In some embodiments, however, the method may require a certain user's approval before the modified schematic is displayed to a different user.

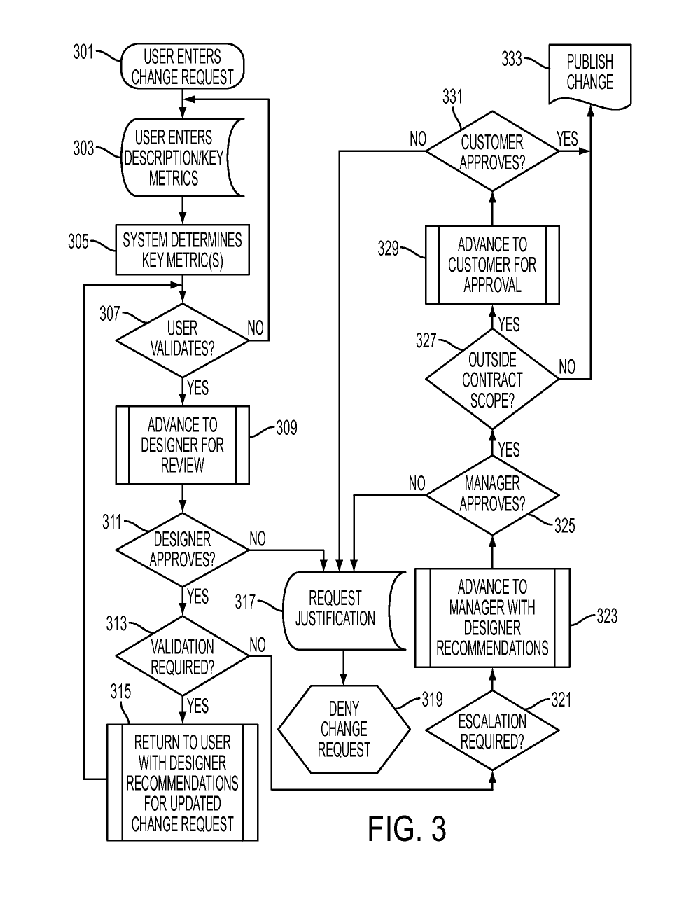

FIG. 3 illustrates an example of a workflow for validating a change request in accordance with one embodiment. The workflow is shown in this example for a workgroup that includes at least three members and a customer, and each of the members has a rank so that one member (in this case a designer) must approve a change request before it proceeds to the next higher rank (in this case a manager) for review. When a user accesses the system, the user may be required to enter an access credential, such as a username and password. Optionally, the system may capture this information as a digital signature. If the system does not recognize the access credential, the system may deny the user access to the system. If the system does recognize the access credential, then the system may permit the user to access the system. Optionally, the system may access a data store to determine a user category or permission level to which the user is assigned. The system may then use this information this to assess permissions and limit what action the user may take, or what information that the user may access, through the system.

Referring to FIG. 3, a user may enter a change request 301 into the system by entering a description of the change into the user input interface. The change request can include, for example, a change in identity of an asset, a change in the number of a type of asset, or a change in the location of an asset.

The user may enter a description of the change along with one or more key metrics such as cost or physical space required 303. Alternatively or in addition, the system may automatically determine one or more key metrics 305. The system may do this, for example, by accessing a database and determining key metrics that are stored in the database that correspond to information that the user enters, such as a category or model number of a print-related device. The system may then display the change as a modified schematic and/or the key metrics on the user interface for the user validation 307. If the user does not accept the changes, the user may modify the change description and/or the key metrics 303. Otherwise, if the user validates or if validation is not required, the system may advance the change request to one or more next levels for review 309. All of this is done without printing the change request, as the change request and schematic files are stored on a computer-readable memory and distributed to other users via a networked server.

As described above, based on the user's user category or permission level, the system may limit the types of change that a user may request. For example, the user may be limited to one or more of the following tasks: move a location of a device; add a new device, change a configuration or setting of a device, and remove a device. Other limitations may apply,

When advancing the change request 309, the system may store the change request as a data file in the networked data store and notify the next level designer(s) or other user(s) that the change request is available for review. The next user may be given the opportunity to review and approve the change 311. Optionally, the next user approval may include one or more conditions and/or modifications. If the next user does not approve the change, optionally the system may require or request that user to submit a justification for the disapproval 317. The system may then deny the change request and not implement it in the environment to be shared with other users 319. Otherwise, if the designer approves the change, the user who initiated the change may be given the opportunity to validate the designer's approval 313, and if so the designer's approval and any designer-initiated changes and conditions will be sent to the user 315 so that the user can implement the designer's recommendations as an updated change request. When returning rejections or modifications to a user, the user may be also receive a notification that the change is available by email, text message, via a mobile communications device application, or via another electronic communication. Otherwise, if the user validates or if validation is not required, the system may escalate the change request to one or more next levels for review 321.

For example, the system may advance the change request to a manager 323, optionally along with the designer's recommendations and/or conditions. The manager may be given the opportunity to review and approve the change 321. Optionally, the manager approval may include one or more conditions and/or modifications. If the manger does not approve the change, optionally the system may require or request that the manager submit a justification for the disapproval 317. The system may then deny the change request and not implement it in the environment to be shared with other users 319.

Otherwise, if the designer approves the change, the system may determine whether the change is inside or outside of a contract scope 327. The system may determine this based on user input from any one of the change initiator, the designer, and/or the manager. Alternatively, the system may use the key metrics for the change and information from the data store to determine whether the change is out of scope. For example, the system may determine whether the cost key metric for the change will result in a total project cost that exceeds a threshold cost. If the change is within scope, the system may publish the change 333, such as by updating the project file or uploading the change to the data store so that the change can be shared with all users, designers and/or managers who are permitted to access the file.

If the change is outside of scope, the change request may be sent to a customer for approval 331. If the customer approves the change, the change may be published to other workgroup members 333 as described above.

Therefore, in some embodiments, upon receipt of a change request, the system may cause the modified environment schematic to be displayed on a display for approval and receive, via a user interface from a first user, an approval instruction. In response to the approval instruction of the modified schematic, the approved modified schematic can then be distributed a second user for additional approval. In some embodiments, the approved schematic or the modified schematic is distributed electronically. It can be distributed via e-mail or through a link on a website, or by another means.

In some embodiment, the system may implement one or more change restrictions that limit what a user is allowed to modify. For example, the user can be limited in the type of instructions that are allowed to be sent via the user interface. The user, for example, may only be allowed to modify the number of assets, but not the type of assets. In another example, the user may be allowed to modify the type of assets, but not the number or placement of the assets. The user's ability to modify the environment can be unlimited or limited in any manner.

In some embodiments, the modifications made may be limited by one or more pre-defined values. The pre-defined values can be for example, but not limited to, number of workers in the work area; ratio of workers to asset; utilization of the one or more assets; the one or more users revenue; the owner's profit margin, asset type, cost, and one or more users modifications. Other pre-defined values are also described herein and can be used to constrain or otherwise allow for the modification of a schematic.

In some embodiments, a modification may be marked as a conflict. A conflict is a change that is not accepted by a user or by the system. For example, the system may refuse to accept a change that is not consistent with a pre-defined criterion, such as price or device manufacturer. The conflict may be resolved, when a user approves the change that led to the conflict, thus negating the existence of a conflict. Alternatively, the user who initiated the change can resolve the conflict by modifying the change request in a manner that eliminates the conflict.

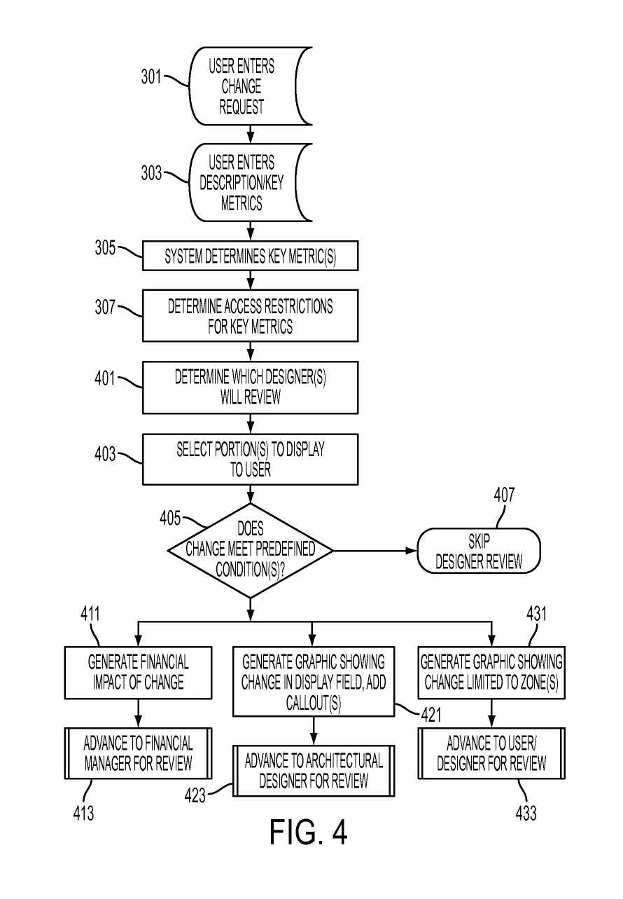

In some embodiments, multiple reviewers may be permitted to view a change request during one or more overlapping time periods. Thus, reviews of a change request may occur in parallel with each other. Alternatively, one user or group of users may be required to complete their review before a change request is advanced to another user or group of users for review. For example, referring to FIG. 4, after a user enters a change request 301 along with a description and/or key metrics 303 or the system determines key metrics 305, the system may determine which designers or other users should review the change request 401. The information given to each designer for review may vary. For example, if the change request will cause a financial impact, such as by increasing a cost of the project, then the system may calculate the amount of financial impact based on the change request and key metrics 411 and advance the relevant financial information to a financial manager for review 413. When doing so, the system may not forward information that is irrelevant to the financial manager's review, such as device layout or user identification details. Similarly, if a change will affect multiple zones of an environment, such as multiple floors of a building or multiple work areas, the system may determine zone-specific information 431, and when forwarding the change request to a user of a zone the system may only provide that user with such details of the change as are necessary to cover assets that are located in the zone 433.

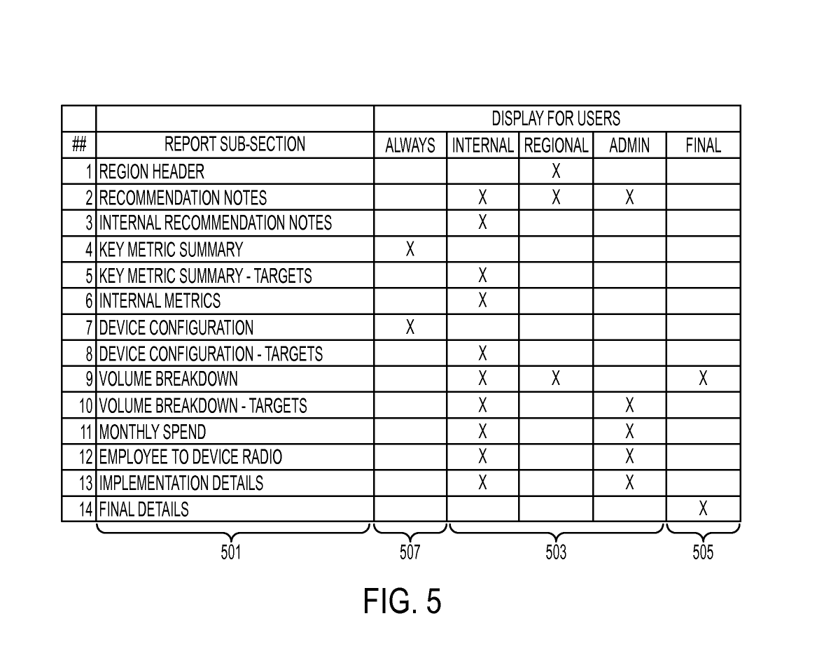

In some embodiments, the system may determine what portion(s) of the key metrics and/or what portion(s) of the schematic to display to individual users or groups of users 351. For example, certain metrics (such as pricing, or one or more target values) may be designated as internal metrics that will not be distributed to users outside of the entity that is managing the system. The system may make this designation based on a user input (e.g., a user may elect to disable a particular user or category of users from viewing a particular metric). Alternatively, the system may automatically make this designation based on one or more rules, such as a rule that access to all target values will be limited to authorized users within a designated entity. FIG. 5 is a table that illustrates an example of a set of metrics and access permission rules. Metrics 501 such as recommendation notes, a key metric summary, device configuration, volume breakdown, monthly spend, employee-to-device ratio, implementation details and final details all may be associated with one or more sets of users 503 (in this case, internal users, users within a certain region or other group, or system administrators), as well as one or more types of reports such as the final report 505. In addition, some metrics may be designated as always made available for each user and in each report 507. Thus, the system may establish user-specific and/or group-specific access permissions for different types of information. For example, internal metrics may not be displayed to external users. As another example, some users may be given access only to metrics and not to a schematic, and vice versa.

Returning to FIG. 4, when the system makes a proposed change available to a user, it may selectively present 403 and display some or all of the schematic, and some or all of the key metrics, to that user. The selection of metrics and schematics will correspond to the designations described above under step 401.

In some embodiments, the system may not require additional approval if the change request meets one or more predetermined criteria 405. For example, the system may assess one or more key metrics of the change request and determine whether each key metric satisfies, is within range of, is less than, or is greater than a target value. If the metric is within the target value, further review may not be required 407. Target values may include, for example: a target number of knowledge workers to device; a target utilization range; a target revenue, spend or cost within a time period; a target profit margin; a target client savings amount; a target volume of pages printed or toner used; and/or other metrics. If the change does not satisfy the target value, it may be escalated for further review, or it may be declined and returned back to the requesting user.

Some users may receive additional information. For example, an architectural designer may benefit by receiving additional information that is not entered by the user who initiated the change. Such information may include device specifications for the asset (e.g., dimensions, weight, cost), while other information may include details about elements of the environment that are not displayed to all users (such as power or network connections that are available in the environment). The system may generate this information by retrieving it from a database and attaching it to or including it with the environment file as a callout that a user may select to receive the additional information 421. The system may then advance this information to an architectural designer for review 423.

Optionally, each user and/or reviewer may be required to enter identifying information, such as a user ID and password. Some or all of the identifying information may be saved in the data store, along with that individual's action (such as approval or disapproval) so that other users may track the history of a change request, who made it, who reviewed it, and what recommendations or conditions were placed.

The instructions, decisions, and/or modifications described above may be specified by a user, a manager, an owner or other person of authority associated with the environment. In an embodiment, pre-defined values (such as thresholds or limiting ranges) associated with an environment may include a maximum number of assets for the environment, a preferred ratio or range of acceptable ratios of users to assets, a maximum operation cost for the environment, and/or other constraints. In some embodiments, a pre-defined value may also include a spatial entity that is identified for one or more of the assets currently in the environment. A spatial entity may include an area surrounding an asset. A spatial entity may include one or more users of the asset who are located within the area. For example, in an office environment, a spatial entity may encompass the users associated with one or more offices, desks, cubicles and/or the like located within the environment. In an embodiment, a spatial entity may be associated with one or more coordinates. The coordinates may be those associated with a map of the environment and/or the like.

In an embodiment, each spatial entity may be associated with print volume information. Print volume information may represent the volume processed by the asset (e.g. print-related device) in the spatial entity over a certain period of time. For example, if the asset in a spatial entity is a printer, the print volume information associated with the spatial entity may include the total number of sheets processed by the printer over a certain period of time. In an embodiment, the print volume information may include the total number of sheets processed by the printer for users within the spatial entity over a certain period of time.

In an embodiment, print volume information may include a volume associated with different types of documents that are processed by an asset. For example, print volume information may include black print volume, black copy volume, fax volume, color print value, color copy volume, color scan volume and/or the like. Print volume information may include the volume associated with other capabilities performable by a certain print-related device.

In an embodiment, print volume information may be determined from actual usage data from a print-related device. For example, one or more print-related devices in an environment may be inventoried, and the output from such devices may be measured over a period of time. Alternatively, print volume information may be received from computing devices associated with one or more users within a spatial entity. For example, a user may be associated with a computer, workstation and/or the like that the user may use to print a document. The print volume information associated with this print job may be collected from a user's computing device.

In an embodiment, each spatial entity may be associated with capability information. Capability information may include the functions or operations that are performable by an associated print-related device. For example, in a document environment, capabilities may include fax, copy, scan, print, finishing operations and/or the like. This information may be stored in the data store.

In an embodiment, spatial entities may be grouped into one or more capability groups based on the print volume information, the capability information and the coordinates associated with one or more of the spatial entities. A capability group may represent a group of users, print volume information associated with the users' output and any capabilities required by the users. In an embodiment, a capability group may include an aggregation of the print volume information, users and capabilities of the spatial entities that comprise the capability group. For example, if a capability group is formed from a first spatial entity associated with fax capability and a second spatial entity associated with black and white print capability, the capability group may be associated with both fax and black and white print capabilities.

In an embodiment, a model may be applied to the pre-defined values to determine if the modified schematic would be acceptable and fit within another arrangement of pre-defined values. The model may be a linear programming model, a simulation model and/or the like. Additional and/or alternate models may be used within the scope of this disclosure.

The model may vary the permutations of the pre-defined values for the environment. Other pre-defined values include product profiles, which may include information associated with one or more of the assets such as costs, volume levels, capabilities, quantity limits and/or the like. Constraints on the pre-defined values can also be used. For example constraints on the pre-defined values include, but are not limited to, employee to device ratio, printer to device ratio, required minimum volumes, enforcement of quantity limits on a device, minimum convenience printing, minimum black on color product, and/or the like.

In an embodiment, minimum convenience printing may be accomplished by identifying one or more print-related devices. In an embodiment, the identified devices may be identified as convenient devices. A convenient print-related device may be one that is located relatively close in proximity to one or more users. The convenience of a print-related device may be determined by a footprint associated with the device, accessories associated with a device, capabilities associated with a device and/or the like. In an embodiment, the model may associate a certain percentage of print volume with the identified devices.

In an embodiment, minimum black on color product may be a constraint that may require the model to associate a certain percentage of black print volume with a print-related device that prints in black ink and color ink.

The pre-defined values may also be based upon physical constraints of the environment. For example, a device location may be constrained based on the available power supply, space and/or the like. Thus, a modification instruction may be rejected or marked as a conflict because of a physical constraint. These constraints can be built into the user interface such that it will be marked as such before being displayed in a modified schematic.

The distance between devices can also be used as a constraint. For example, a distance between a device location and one or more other device locations in the environment can be used a constraint. A distance may be determined based on coordinates associated with the device location. In an embodiment, a distance between device locations may be measured or estimated on the user interface or schematic.

In an embodiment, the pre-defined values can assist in matching an asset with an asset location. The matching may be based on a number of factors such as the volume information associated with the corresponding spatial entity and/or user or group of users

In an embodiment, a report may be generated. The report may include the final approved schematics. In an embodiment, the report may include an analysis that explains the configuration of the assets. The analysis may include specifications associated with one or more recommended assets, capabilities associated with one or more recommended assets, dimensions associated with one or more assets and/or the like.

In an embodiment, a report may include a location for one or more of the assets and why a certain modification was rejected. The report may include a named location for one or more assets. For example, the report may provide that a first asset should be located in a first copy room. In an embodiment, the report may include coordinates for one or more assets. The report may also include other information, such as volume and/or capability information associated with spatial entity and/or user and/or a group of users, the dimensions of the location and/or the like.

In an embodiment, the report may be displayed to a user. For example, the report may be printed. The report may be emailed, faxed or otherwise transmitted to a user. In an embodiment, a report may be displayed to a user on a computing device.

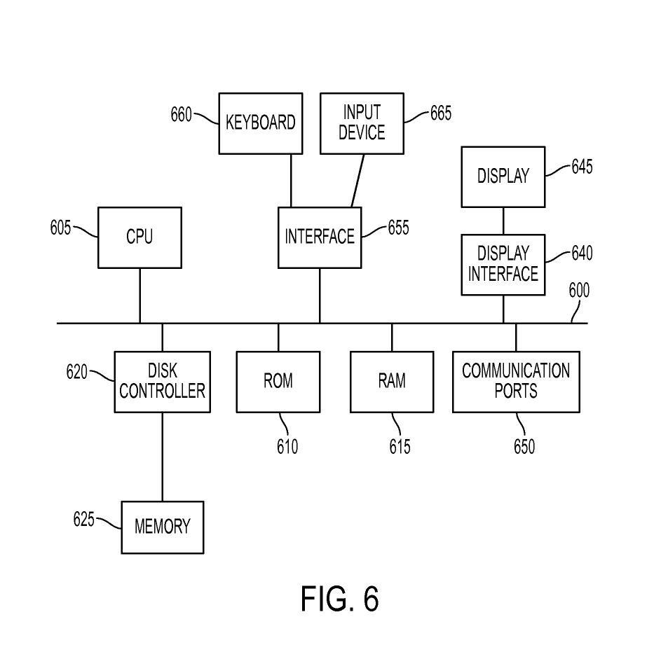

FIG. 6 depicts a block diagram of internal hardware that may be used to contain or implement program instructions, such as the portable electronic devices and servers described above. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 6 is a processing device, computing device or processor as such terms are used within this disclosure. Read only memory (ROM) 610 and random access memory (RAM) 615 constitute examples of memory devices or processor-readable storage media.

A controller 620 interfaces with one or more optional tangible, computer-readable memory devices 625 to the system bus 600. These memory devices 625 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 610 and/or the RAM 615. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 640 may permit information from the bus 600 to be displayed on the display 645 in audio, visual, graphic or alphanumeric format. Communication with external devices, such as a printing device, may occur using various communication ports 650. A communication port 650 may be attached to a communications network, such as the Internet or an intranet.

The hardware may also include an interface 655 which allows for receipt of data from input devices such as a keyboard 660 or other input device 665 such as a mouse, a joystick, a touch screen, a remote control, a pointing device, a video input device and/or an audio input device.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method of implementing a workgroup configuration of a document production environment, comprising:
displaying, on an electronic display, a schematic of a work area depicting placement of one or more print-related devices in the work area;
receiving, via a user interface, an instruction, wherein the instruction identifies at least one of the print-related devices;
in response to the instruction, modifying one or more characteristics of one or more of the print-related devices in the schematic to produce a modified schematic;
determining a key metric relating to the identified one or more devices;
displaying the modified schematic and the key metric on the display for approval; and
receiving, via the user interface from a first user, an approval;
in response to the approval, distributing the modified schematic to a second user for additional approval;
receiving, from the second user, an additional approval of the modified schematic,
wherein the method is performed without printing a physical copy of either the schematic or the modified schematic until after the additional approval is received.

2. The method of claim 1, further comprising
receiving, via the user interface from the first user, a modification instruction for the modified schematic;
revising the modified schematic to produce a second modified schematic;
displaying the second modified schematic on the display for approval;
receiving, via the user interface, a second approval or a second modification instruction; and
in response to the second approval, distributing the second modified schematic to a another user for additional approval or in response to the second modification instruction repeating the instructions until no additional modification instructions are received and the schematic is approved.

3. The method of claim 1, further comprising receiving a notification that the modified schematic has been approved.

4. The method of claim 1, further comprising:
determining whether the second user is authorized to access the key metric; and
when distributing the modified schematic to the second user for approval, including the key metric in the distributing only if the second user is authorized to access the key metric.

5. The method of claim 1, wherein the instruction comprises an instruction to:
add an additional print-related device;
remove at least one of the print-related devices;
change a location of at least one of the print-related devices; or
modify a device configuration of at least one of the print-related devices.

6. The method of claim 1, wherein the modifying one or more characteristics of one or more of the print-related devices in the schematic comprises modifying the electronic display of the schematic to:
add an additional print-related device;
remove at least one of the print-related devices;
change a location of at least one of the print-related devices; or
modify a device configuration of at least one of the print-related devices.

7. The method of claim 1, further comprising:
determining whether the instruction is limited by one or more conditions; and
if so, only performing the modifying if the instruction satisfies the one or more conditions.

8. The method of claim 7, wherein the one or more conditions comprise one or more of the following:
a number of workers in the work area;
a ratio of workers to print-related devices;
a print-related device type; and
a cost.

9. The method of claim 1, further comprising, in parallel with the distributing of the modified schematic to the second user:
identifying a third user;
creating a limited version of the modified schematic for review and approval by the third user;
distributing the limited version of the modified schematic to the third user for approval; and
making the modified version of the schematic available to all users of a workgroup only if approval is received from the third user.

10. The method of claim 9, further comprising:
determining that at least one of the users has not approved the modified schematic;
identifying the modified schematic as a conflict; and
resolving the conflict.

11. The method of claim 10, wherein resolving the conflict comprises removing a change that resulted in the conflict.

12. A system for determining placement of one or more assets in a work area comprising, the system comprising:
a computing device; and
a computer-readable storage medium in communication with the computing device, wherein the computer-readable storage medium comprises one or more programming instructions for:
displaying, on an electronic display, an schematic of a work area depicting placement of one or more assets in the work area;
receiving, via a user interface, an instruction;
in response to the instruction, modifying one or more characteristics of one or more of the assets in the schematic to produce a modified schematic;
determining a key metric relating to the one or more assets for which the characteristics were modified;
displaying the modified schematic on the display for approval; and
receiving, via the user interface from a first user, an approval instruction;
in response to the approval instruction, distributing the modified schematic to a second user for additional approval; and
receiving, from the second user, an additional approval of the modified schematic.

13. The system of claim 12, wherein the programming instructions also comprise instructions for:
receiving, via the user interface from the first user, a modification instruction for the modified schematic;
revising the modified schematic to produce a second modified schematic;
displaying the second modified schematic on the display for approval;
receiving, via the user interface, a second approval or a second modification instruction; and
in response to the second approval, distributing the second modified schematic to a another user for additional approval or in response to the second modification instruction repeating the instructions until no additional modification instructions are received and the schematic is approved.

14. The system of claim 13, wherein the programming instructions also comprise instructions for:
determining whether the second user is authorized to access the key metric; and
when distributing the modified schematic to the second user for approval, including the key metric in the distributing only if the second user is authorized to access the key metric.

15. The system of claim 12, wherein the instruction received from the first user comprises a command to:
add an additional print-related device;
remove at least one of the print-related devices;
change a location of at least one of the print-related devices; or
modify a device configuration of at least one of the print-related devices.

16. The system of claim 15, wherein the modifying one or more characteristics of one or more of the print-related devices in the schematic comprises modifying the electronic display of the schematic to:
add an additional print-related device;
remove at least one of the print-related devices;
change a location of at least one of the print-related devices; or
modify a device configuration of at least one of the print-related devices.

17. The system of claim 12, wherein the programming instructions also comprise instructions for:
determining whether the instruction is limited by one or more conditions; and
if so, only performing the modifying if the instruction satisfies the one or more conditions.

18. The system of claim 12, wherein the programming instructions also comprise instructions for, in parallel with the distributing of the modified schematic to the second user:
identifying a third user;
creating a limited version of the modified schematic for review and approval by the third user;
distributing the limited version of the modified schematic to the third user for approval; and
making the modified version of the schematic available to all users of a workgroup only if approval is received from the third user.

19. The system of claim 12, wherein the programming instructions also comprise instructions for:
determining that at least one of the users has not approved the modified schematic;
identifying the modified schematic as a conflict; and
resolving the conflict.

20. The system of claim 19, wherein resolving the conflict comprises removing a change that resulted in the conflict.
